(19) United States
(12) Patent Application Publication
(10) Pub. No.: US 2017/0027245 A1
(43) Pub. Date: Feb. 2, 2017

(54) SUSPENSION SYSTEM AND METHOD

(71) Applicants: Steve Miller, Charleston, SC (US); Lee Bailey, Raleigh, NC (US)

(72) Inventors: Steve Miller, Charleston, SC (US); Lee Bailey, Raleigh, NC (US)

(21) Appl. No.: 15/062,628

(22) Filed: Mar. 7, 2016

Related U.S. Application Data
(63) Continuation of application No. 13/835,514, filed on Mar. 15, 2013, now abandoned.
Application No. 13/835,514 is a continuation-in-part of application No. 13/466,722, filed on May 8, 2012, now abandoned.
Application No. 13/466,722 is a continuation-in-part of application No. 12/102,718, filed on Apr. 14, 2008, now abandoned.

(51) Int. Cl. A41D 13/00; G21F 3/02; F16M 13/02; A41D 13/12

(52) U.S. Cl. CPC A41D 13/0007; A41D 13/0002; A41D 13/1209; G21F 3/02; F16M 13/027

(57) ABSTRACT

An apparatus suspends a personal radiation protection garment above a work surface. The suspension apparatus comprises a support member positioned above the work surface, a cable mechanically suspended from the support member, and means for counter-balancing the weight of the personal radiation protection garment attached to the cable. Means for attaching the counter-balancing means to the personal radiation protection garment suspend the personal radiation protection garment. The attaching means includes means for disconnecting the garment from the counter-balancing means, the disconnecting means manually operable by one hand of a user and disposed within reach of the user while wearing the personal radiation protection garment attached to the counter-balancing means. The personal radiation protection garment is supported in suspension and may be disconnected from the counter-balancing means by the one hand of the user for releasing the personal radiation protection garment from suspension while still being worn by the user.

### CROSS-REFERENCES

This application is a continuation application of U.S. patent application Ser. No. 13/835,514, filed Mar. 15, 2013, which is a continuation-in-part application of U.S. patent application Ser. No. 13/466,722, filed May 8, 2012, which is a continuation-in-part application of U.S. patent application Ser. No. 12/102,718, filed Apr. 14, 2008, the contents of all of which are hereby incorporated herein by reference in their entirety.

### BACKGROUND

This invention relates generally to a suspension system and method, and more particularly to a system and method for suspending medical equipment and instruments in a medical environment.

The practice of medicine can be a physically demanding job, potentially creating health problems for those practicing medicine. For example, a medical operator may expose his body to radiation, which is used to perform many medical diagnostic and therapeutic tests and procedures, such as cardiac catheterizations. To minimize this exposure to radiation, operators commonly wear protective garments containing radiation-absorbing materials, generally lead or other metals, which are worn in the fashion of a vest and apron or a full lead jacket which reaches from the shoulder to the knees. These garments are uncomfortable, heavy and place significant stress on the operator's body, especially the spine. This may present a significant logistic and health challenge for medical operators in radiation environments, such as a catherization laboratory. Indeed, the effects of an operator wearing such a heavy protective garment over an extended period of time is known to be associated with diseases of the spine in the neck and back, knee disorders, and other musculoskeletal problems, which can result in disability, medical expenses, and decreased quality of life for the operator.

For the foregoing reasons, there is a need for a suspension system and method for use in a medical environment. In one aspect, the suspension system and method should allow an operator to wear a personal radiation protection garment minimizing the weight on his body, while not substantially limiting his freedom of movement. In another aspect, the suspension system should allow the operator to quickly release the garment from the suspension system so as to allow an operator wearing the garment to move free of the suspension system.

### SUMMARY

An apparatus is provided for suspending a personal radiation protection garment above a work surface defining an area. The suspension apparatus comprises a support member adapted to be positioned above the work surface, a cable mechanically suspended from the support member, and means for counter-balancing the weight of the personal radiation protection garment, the counter-balancing means attached to the cable. Means for attaching the counter-balancing means to the personal radiation protection garment suspend the personal radiation protection garment. The attaching means includes means for disconnecting the garment from the counter-balancing means, the disconnecting means manually operable by one hand of a user and disposed within reach of the user while wearing the personal radiation protection garment attached to the counter-balancing means. The personal radiation protection garment is supported in suspension when attached to the counter-balancing means, and the personal radiation protection garment may be disconnected from the counter-balancing means by the one hand of the user for releasing the personal radiation protection garment from suspension while still being worn by the user.

### BRIEF DESCRIPTION OF THE DRAWINGS

For a more complete understanding of the present invention, reference should now be had to the embodiments shown in the accompanying drawings and described below. In the drawings:

FIG. 1 is a perspective view of an embodiment of a suspension system for a personal radiation protection garment.

FIG. 2 is a front elevation view of the suspension system as shown in FIG. 1.

FIG. 3 is a side elevation view of the suspension system as shown in FIG. 1.

FIG. 4A is a perspective view of a cross-section of a portion of the suspension system as shown in FIG. 1.

FIG. 4B is a perspective view of a cross-section of a portion of the suspension system as shown in FIG. 4A including an embodiment of a dust plate.

FIG. 5 is a front elevation view of a portion of the suspension system as shown in FIG. 1, including an embodiment of a hanger and a connecting system.

FIG. 6A is a front elevation view of the hanger and a portion of the suspension system as shown in FIG. 1, including an embodiment of means for connecting the hanger to the suspension system.

FIG. 6B is an exploded front elevation view of the hanger and the portion of the suspension system as shown in FIG. 6A.

FIG. 7 is a perspective view of a portion of the hanger and the connecting system as shown in FIG. 5.

FIG. 8 is a perspective view of the suspension system as shown in FIG. 1 including two operators wearing suspended personal radiation protection garments.

FIG. 9 is a front elevation view of the suspension system as shown in FIG. 8.

FIG. 10 is a perspective view of the suspension system as shown in FIG. 1 including three operators wearing suspended personal radiation protection garments.

FIG. 11 is a front elevation view of the suspension system as shown in FIG. 10.

FIG. 12 is a rear elevation view of a portion of the suspension system as shown in FIG. 1, including another embodiment of a hanger and a connecting system.

FIGS. 13A-13C are rear elevation views of a portion of the suspension system as shown in FIG. 1, including a third embodiment of a hanger and connecting system

FIG. 14A is a rear perspective view of a portion of the suspension system as shown in FIG. 1, including a third embodiment of a hanger and a connecting system.

FIG. 14B is a rear elevation view of a portion of the suspension system as shown in FIG. 14A.

FIG. 15 is a rear perspective view of a portion of the suspension system as shown in FIG. 1, including a fourth embodiment of a hanger and a connecting system.

FIGS. 16A and 16B are rear and side elevation views, respectively, of the personal radiation protection garment showing a reinforced back portion.

FIGS. 17A and 17B are rear and side elevation views, respectively, of the personal radiation protection garment showing another embodiment of a reinforced back portion.

### DESCRIPTION

Certain terminology is used in the following description for convenience only and is not limiting. The words “right”, “left”, “top”, and “bottom” designate directions in the drawings to which reference is made. The words “interior” and “exterior” refer to directions toward and away from, respectively, the geometric center of the core and designated parts thereof. The terminology includes the words above specifically mentioned, derivatives thereof and words of similar import.

A suspension system is described for use in suspending medical equipment and instruments and may be used with any conventional suspension system such as, for example, the system described by U.S. Pat. No. 7,608,847, issued Oct. 27, 2009, and entitled “System and Method for Implementing a Suspended Personal Radiation Protection System,” and the system described by U.S. Pat. No. 7,973,299, issued Jul. 5, 2011, and entitled “System and Method for Providing a Suspended Personal Radiation Protection System,” the contents of both of which are hereby incorporated by reference in their entirety. Accordingly, detailed explanations of the functioning of all of the components and method of such suspension system are deemed unnecessary for understanding of the present invention by one of ordinary skill in the art.

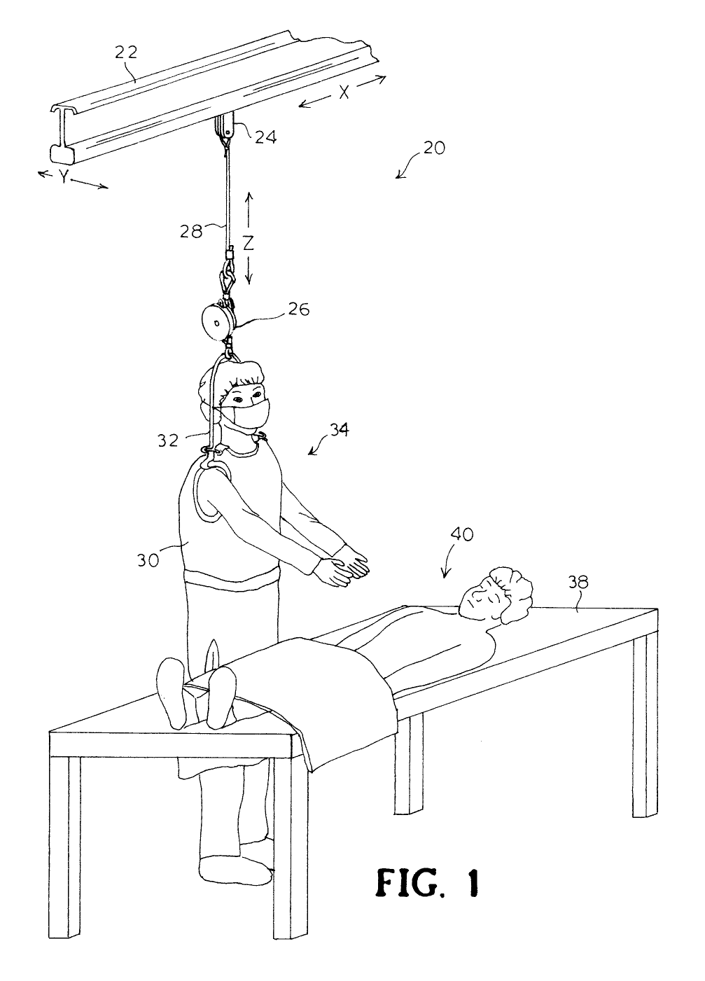

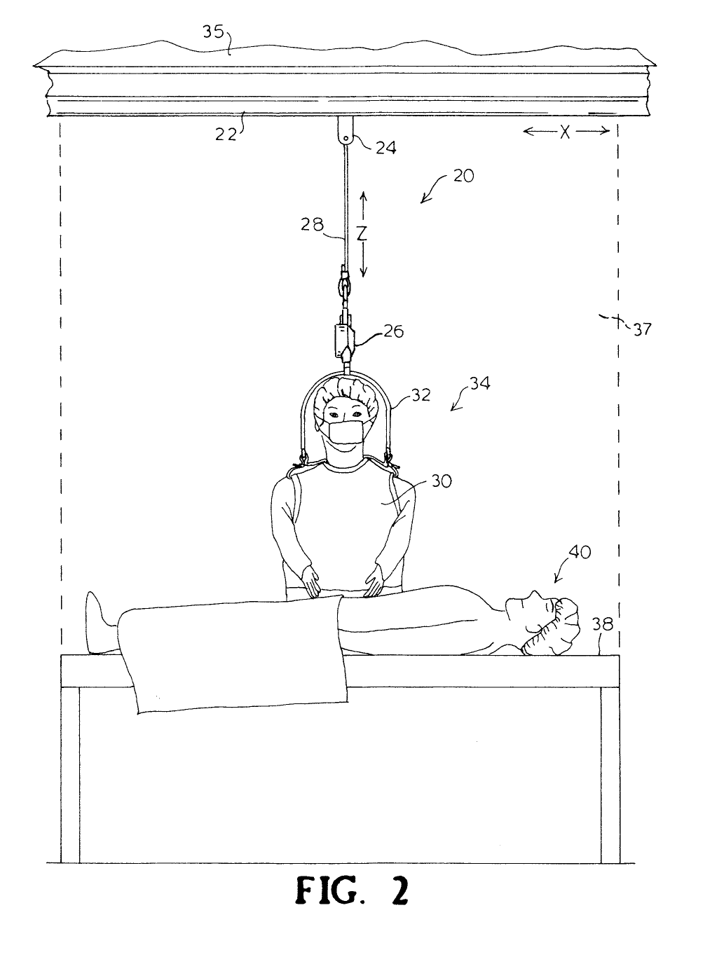

Referring now to the drawings, wherein like reference numbers refer to like elements in each of the several views, FIGS. 1-3 show a suspension system according to an embodiment of the present invention, which is generally designated at 20. The suspension system 20 comprises a rail 22, a trolley 24, a balancer 26 and a cable 28. A personal radiation protection garment 30 worn by an operator 34 is suspended from a hanger 32 which, in turn, is suspended from the suspension system 20. A radiation source (not shown) may be proximate to the operator 34. The radiation source may include any device emitting radiation. For example, in medical procedures, radiation sources may include x-ray machines, nuclear medicine, and devices used for radiation therapy. Other architectures and components of the suspension system 20 may be used without departing from the scope of the present invention.

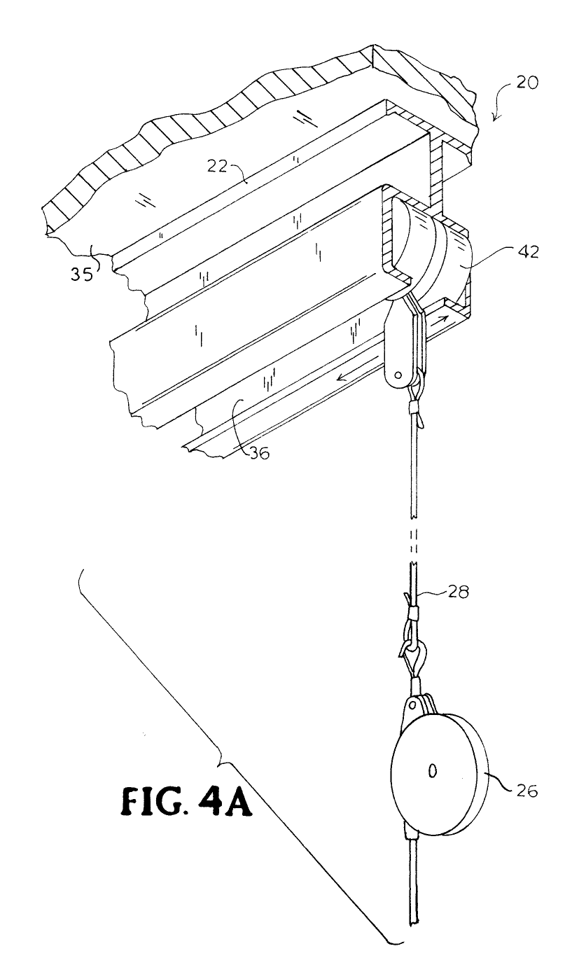

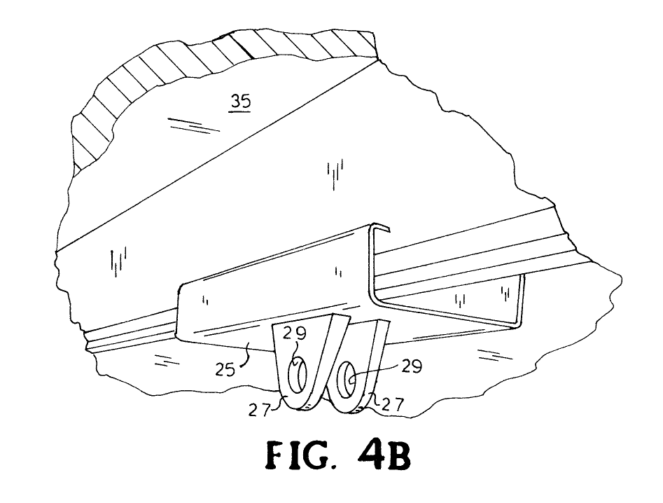

Referring to FIG. 4A, a portion of the rail 22 is shown secured to a ceiling 35. The rail 22 can be permanently affixed to, for example, support structures in the ceiling 35 by any means, such as by bolts, screws and the like (not shown). The rail 22 may be made of any suitable material, such as steel or aluminum, which is strong enough to support the weight of the remainder of the suspension system 20 and the suspended personal radiation protection garment 30. For example, the rail 22 can be constructed of one or two I-rails. The rail 22 defines a track 36 on which the trolley 24 slides or rolls. The track 36 may be linear such that the trolley 24 may move only linearly along the axis that the rail 22 is aligned. For example, in FIG. 1, the rail 22 is shown as aligned along an X-axis and the trolley 24 only moves relative to rail 22 along the X-axis. In one embodiment, the rail 22 may have at least one non-linear section (not shown), such as one or more curved sections. In another embodiment, the rail 22 may have an oval or circular shape. Therefore, it is understood that the rail 22 may comprise straight sections, linear sections, or combinations thereof.

The rail 22 may be affixed to any suitable supporting structure, in addition to or other than the ceiling 35, including a wall, floor, mobile structure, mobile frame, immobile frame, cable, or any other mechanical means for hanging an item over the head of an operator. While any supporting structure may be employed to mount the rail 22 thereto, the present invention describes and illustrates the rail 22 being affixed to the ceiling 35 as only an exemplary location to mount the rail 22. One skilled in the art would recognize that any other supporting structure may be substituted for the ceiling 35.

Referring to FIGS. 1-3, the rail 22 may be affixed to the ceiling 35 at any location. For example, the rail 22 may be secured to a portion of the ceiling 35 that is directly above a non-operating area, which may be any area that is not directly above an operating surface 38, such as a medical operating/surgery surface or patient examination surface. In one embodiment, the rail 22 may be aligned along a linear axis that is adjacent to a prismoidal space 37 above any medical operating or patient examination surface 38 (e.g. a medical bed, an operating table, and the like). The prismoidal space 37 may extend directly above the medical operating surface 38 to a portion of the ceiling 35 corresponding to the medical operating surface 38. As shown in FIGS. 1-3, the X-axis is adjacent and parallel to one side of the prismoidal space 37 between the operating surface 38, for example a patient's bed, and the corresponding ceiling 35 directly thereabove.

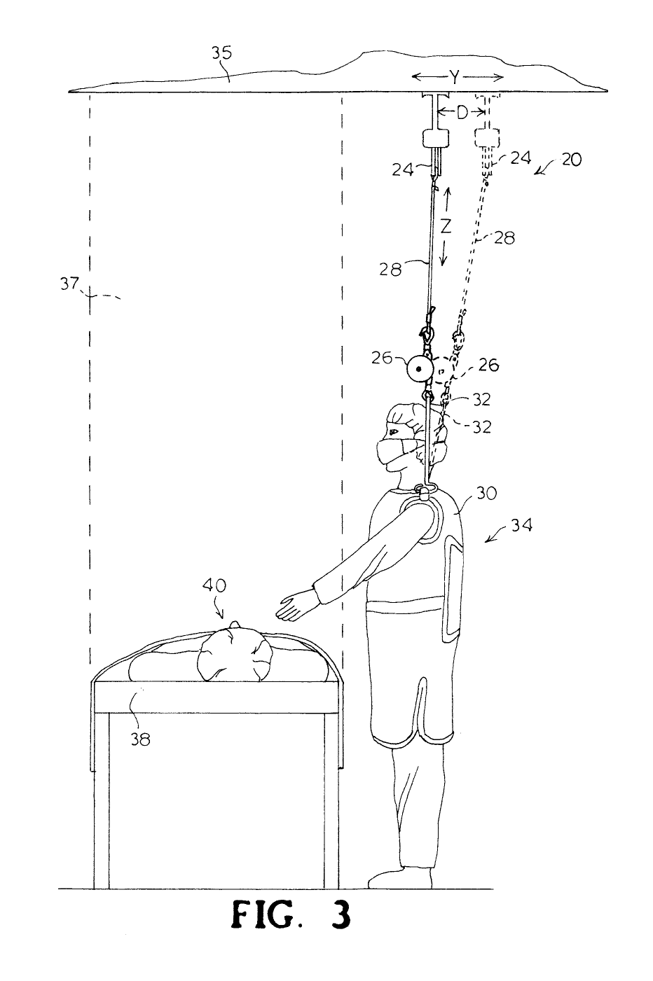

Referring in particular to FIG. 3, the rail 22 may be placed directly over where the operator 34 stands adjacent the operating surface 38 or a distance “D” behind the operator 34 when the operator 34 is standing upright and facing the operating surface 38 or operating table/bed. The rail 22 may run parallel with the operating surface 38, workplace, or medical bed, such that the rail 22 represents the length of the X-axis that the operator 34 can move freely within while utilizing the suspension system 20. Preferably, the rail 22 is not placed directly over the operating surface 38. For example, the rail 22 may not be placed directly over where a patient 40 will be located during radiation treatments/operations.

Referring again to FIG. 4A, the trolley 24 can include a roller 42, such that the trolley roller 42 is positioned in the runway or track 36 of the rail 22. The roller 42 is operable to easily slide or roll along the track 36, such that the operator 34 can move freely. The trolley 24 can attach via the cable 28 to the balancer 26, which suspends the personal radiation protection garment 30, such that the operator 34 can move freely in the X-spatial plane, defined by the X-spatial axis and the vertical Z-spatial axis. The X-spatial plane is designed to correspond to the operator's 34 desired work area. The operator 34 wearing the suspended personal radiation protection garment 30 may have a smooth and facile motion within this plane.

Referring to FIG. 4B, a dust plate 27 may be mounted to the trolley 24 to capture dust or debris released from or pushed out of the track 36 by movement of the trolley 24. A pair of downwardly depending ears 27 are provided and each define an opening 29 for suspending the remainder of the suspension system 20 to the dust plate 27.

Although the operator 34 is allowed free movement along the X-axis, limited movement may be allowed for the operator 34 along the Y-axis perpendicular to the X axis. The operator 34 generally moves along the X-axis and thus, most of the operator's movements are confined thereto. However, the operator 34 is still allowed some movement along the Y-axis. For example, the operator 34 is allowed to bend forward or walk forward or backwards to the extent of the extension of the cable 28 attached to the counter balancer 26.

In another embodiment, the suspension system 20 can include linear motion devices or any other suitable means for allowing the trolley 24 to move freely relative to the rail 22. For example, the trolley 24 can include roller bearings operable to roll inside a guide included in the rail 22, such that facile motion of the trolley 24 relative to the rail 22 is allowed. The suspension system 20 is operable by any suitable means to allow free motion along a path defined by the rail 22 for the operator 34 wearing the suspended personal radiation protection garment 30.

In one preferred embodiment, the cable 28 may be suspended from the trolley 24 and may attach to the balancer 26. In another embodiment, the cable 28 may be suspended from the balancer 26 and may attach to the hanger 32. In yet another embodiment, the cable 28 may be suspended from the rail 22 and connect to the balancer 26. The cable 28 may be a strap, a rope or a belt. The cable 28 may be several feet long and allow the operator 34 to move extensively in the X-axis and extensively in the vertical Z-axis. For example, the cable 28 may allow the operator to move six feet end-to-end along the X-axis and four feet along the Z-axis. The cable 28 also allows the operator 34 to move slightly outside the perimeter of the X-spatial plane. The cable 28 can include a swivel mount that permits free rotation of the cable suspension mechanism allowing the operator 34 to twist as needed. This may include a swivel hook or snap that connects the cable 28 to the balancer 26 or the rail 22. The cable 28 is operable to safely hold the amount of weight and force caused by the suspended personal radiation protection garment 30.

As described above, the balancer 26 may be attached to the trolley 24 by the cable 28. The balancer 26 applies a constant and controllable uplifting force on the personal radiation protection garment 30. In one embodiment, the balancer 26 may be a spring balancer, which can include a coiled flat spring, similar to a clock spring, attached to a reel with a conical shape. The conical shape provides a variable mechanical advantage, which offsets the variance of the force provided by the spring as it winds or unwinds, such that there is a relatively constant force on the cable 28 within a definable working range. The counterweights apply the same amount of force to the garment 30 regardless of how much cable may be extended out of the counter-balancer 26. The tension can be designed to provide optimum relief of the garment's weight for the operator 34, and this force can be constant in all positions of the operator 34. The spring balancer applies a constant force to oppose the weight regardless of how much the cable 28 is extended.

In a preferred embodiment, the balancer 26 can be a zero gravity counter-balancer. The counter-balancer may be attached directly to the cable 28 or to the trolley 24. The amount of counterweight may be substantially equal to the weight or load suspended from the counter-balancer. When the garment 30 is attached to the counter-balancer, the counter-balancer may apply a constant and controllable uplifting force on the garment 30. When the garment 30 is not attached to the counter-balancer, the counter-balancer only counter-balances the load, if any, that may be attached to the counter-balancer.

The counter-balancer may be a variable counter-balancer such that the amount of weight that the counter-balancer may offset is variable. The variable counter-balancer may be adjusted by hand or remotely such that the user may increase or decrease the amount of weight that the counter-balancer will offset. This may be useful if one or more different types of personal radiation protection garments 30 having different weights will be attached to the counter-balancer.

The counter-balancer is attached to the cable 28 that hangs from the trolley 24 or rail 22. The cable 28 may be long enough such that the counter-balancer is within an arms-reach of the operator 34 such that the operator 34 may be able to adjust the variable counter-balancer while the operator 34 stands on the floor. However, the counter-balancer may alternatively be attached proximate to the rail 22 by connecting directly to the trolley 24 or by connecting to a short cable 28 that is attached to the trolley 24.

A suitable counter-balancer for use in an embodiment of the suspension system 20 is available from Packers Kromer of Omaha, Nebr. Similar suitable counter-balancers are described in U.S. Pat. Nos. 6,042,087 and 7,424,997, the contents of both of which are hereby incorporated by reference in their entirety.

In a further embodiment, the balancer 26 may be counterweights. The counterweights apply constant and controllable uplifting force on the garment 30. The counterweights allow the operator 34 wearing the suspended personal radiation protection garment 30 freedom of motion in the vertical Z-axis spatial plane.

In yet another embodiment, the balancer 26 can be a constant force spring. The constant force spring applies constant and controllable uplifting force on the garment 30. The constant force spring allows the operator 34 wearing the suspended personal radiation protection garment 30 freedom of motion in the vertical Z-spatial plane. The constant force spring applies a constant force to oppose the weight regardless of how much the cable 28 is extended.

In other embodiments, the balancer 26 can include a pneumatic balancer, an air balancer, a spring motor arrangement, an intelligent assist device, or any other system which provides a counterbalancing function or suspension system 20 for the suspended personal radiation protection garment 30.

In another embodiment of this invention, servo mechanisms (not shown) can be used to provide near effortless control and rapid response of the suspension system 20 to bodily motions. The servo mechanisms may be incorporated into all axes, or simply into the vertical motion axis alone. The servo apparatus may have motion sensors that detect operator movement, and can stimulate power-assisted motion and cessation of motion, minimizing the effort of the operator 34 to move the system, and also minimizing any tendency of the system to move the operator 34 after the operator 34 stops moving. The power-assisted motion is achieved by means of motors in conjunction with belts, chains, or cables along the desired axes along the rail 22.

In another embodiment, the balancer 26 may be mounted horizontally along the rail 22 rather than hanging vertically. The balancer 26 when mounted horizontally provides more headroom for the operator 34 in a low ceiling 35 or low suspension environment. A pulley (not shown) can be included over the operator's head that can enable the suspension system 20 to create a constant force, such that the operator 34 does not feel the weight of the suspended personal radiation protection garment 30.

A stop (not shown) may also be included in the system wherein the balancer 26 functions to retract the cable, such as in a zero gravity counter-balancer. The stop is a device attached to the cable and which is operable to engage the balancer 26 and prevent the hanger 32 from going higher than a predetermined level. The stop may engage the balancer 26, such that the stop and the hanger 32 are prevented from moving too high. For example, the operator 34 can remove the suspended personal radiation protection garment 30 as another individual firmly grips the hanger 32, and the hanger 32 could be slowly raised until the stop engages the balancer 26.

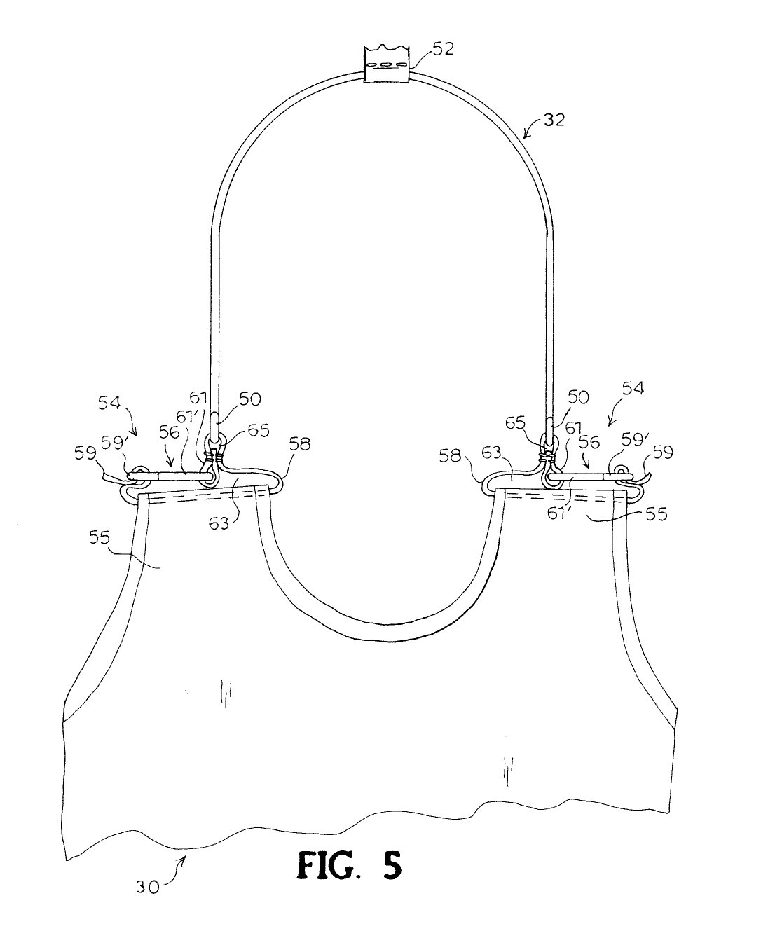

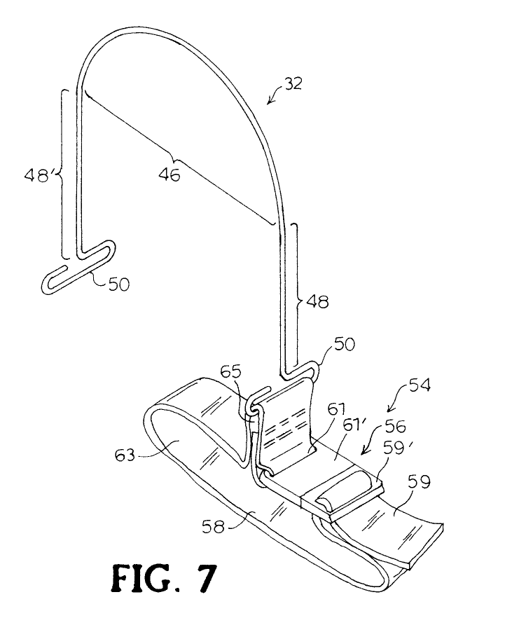

As shown in FIG. 5, the suspension system 20 may further include the hanger 32 configured so that it may be connected to an existing personal radiation protection garment 30. The hanger 32 may include an elongated rigid member 44 or bar bent in a “U” shape, including a curved portion 46 and side portions 48, 48′. Hooks 50 are provided at each end of the side portions 48, 48′ (FIG. 7). The hanger 32 is made of any material that can support at least a minimum weight of the suspended personal radiation protection garment 30. In one aspect, the hanger 32 can be a unified, rigid piece, such that the curved portion 46, side portions 48, 48′ and hooks 50 are integrated.

The curved portion 46 is a portion of the hanger 32 bent into a “U” shape. The curved portion 46 is made of any material that can support at least a minimum weight of the suspended personal radiation protection garment 30. The curved portion 46 is meant to transverse around the top of the operator's head so that the curved portion 46 does not hit the operator's head while in use. The curved portion 46 has a first end and a second end.

The side portions 48, 48′ of the bar 44 are attached to (e.g., as by welding) or integral with (e.g., being one integral piece) the curved portion 46 of the bar 44. Each side portion 48, 48′ of the bar 44 is made of any material that can support at least a minimum weight of the suspended personal radiation protection garment 30. Each side portion 48, 48′ of the bar 44 can attach to or be integral with the hooks 50 of the hanger 32 in various embodiments. In one embodiment, each side portion 48, 48′ of the bar 44 is aligned toward the shoulder sleeve of the personal radiation protection garment 30 close to the neck of the operator 34. This particular embodiment is effective at distributing weight and supporting the suspended garment 30.

The hooks 50 of the hanger 32 may be located at the end of the side portions 48, 48′. Each hook 50 may be made of a material that can support at least a minimum weight of the suspended personal radiation protection garment 30. Each hook 50 is positioned over operator's shoulders. The suspended personal radiation protection garment 30 can be placed on the hooks 50, such that the hooks 50 support the weight of the garment 30. In one embodiment, the hooks 50 can be positioned slightly above the operator's shoulders, such that the hooks 50 act as a substitute for the operator's shoulders while the garment 30 is still substantially contoured to the operator's body.

The hanger 32 is operable to suspend the personal radiation protection garment 30. The hanger 32 may be attached to the cable 28, the counter-balancer 26 or a means for connecting to the counter-balancer 26. The hanger 32 is sized so as to extend above the head of the operator 34 to avoid collision with the operator's head during manipulations. The personal radiation protection garment 30 can be removed from the hanger 32, attached to the hanger 32, or remain suspended from the hanger 32 indefinitely. For example, the garment 30 can rest on the hanger 32 similar to a clothes hanger, such that the garment 30 is not resting on the body of the operator 34.

The hanger 32 may have any means to connect the hanger 32 to the balancer 26. The hanger connecting means may be made of any material that can support a minimum weight of the suspended personal radiation protection garment 30 and the hanger 32. The hanger connecting means may allow the operator 34 to bend sideways, such that the hanger connecting means moves along the hanger 32 to properly distribute weight. The hanger connecting means can be a cable, strap, hook, loop, a pulley, fastener, or any suitable means to attach the hanger 32 to the balancer 26. The hanger connecting means connects the balancer 26 to the bar 44 of the hanger 32. In one embodiment, the hanger connecting means connects to the curved portion 46 of the bar 44 of the hanger 32.

As shown in FIGS. 5 and 7, a connecting system 54 may be provided for connecting the hanger 32 to the garment 30. The connecting system 54 is configured so that it may be connected to existing personal radiation protection garments 30. The connecting system 54 may have a buckle 56 and a strap 58 and is affixed to each hook 50 of the hanger 32. The connecting system 54 is operable for the hanger 32 to be connected to the garment 30, such that the connecting system 54 attaches the shoulder straps 55 of the garment 30 to the hanger 32.

In one embodiment, the strap 58 of the connecting system 54 may be made of a web of material that may support at least a minimum weight of the suspended personal radiation protection garment 30. The strap 58 of the connecting system 54 may be any type of flexible strap and made of any flexible material, such as nylon, some other man-made fiber, cotton, or a mixture of cotton. The straps 58 are longitudinally adjustable and depend from the outer edges of the hanger hooks 50. The length of the straps 58 may be adjustable by means of the buckle 56. Each strap 58 may have one end 59 connected to one portion 59′ of the buckle 56 and another end 61 connected to the other portion 61′ of the buckle 56. The strap 58 forms a circle 63 when the two portions of the buckle 56 are attached to each other. The straps 58 are attached to the shoulder region of the garment 30 when on the garment 30. The distance between the straps 58 should be wide enough so that the head of the operator 34 can easily pass through the opening of the garment 30 and be clear of the straps 58. Each strap 58 may be threaded through the head opening and out of the arm opening of the garment 30. The buckles 58 secure the straps 58 in endless loops.

Two adjacent portions of strap 58 may be sewn together to form a small loop 65. The loop 65 is operable to connect to one of the hooks 50 of the hanger 32. The loop 65 is also operable to support at least a minimum weight of the suspended personal radiation protection garment 30. The loop 65 may be located at any portion along the strap 58. The size of the loop 65 is large enough to connect to one of the hooks 50 but is small enough so that the loop 65 is secure within the hook 50. The loop 65 is operable for rotational motion or swivel motion of the loop on the hanger 32. This allows the operator 34 to freely move in forward bending or rearward bending bodily motions. The swivel motion of the loop 65 on the hanger 32 will allow the hanger 32 to maintain a desirable vertical orientation rather than being forced into a tilted angulation, which would apply additional undesirable forces on the hanger 32 and the suspension system 20, as well as place additional downward forces on the cable 28.

A pulley (not shown) may be attached between the cable 28 and the hanger 32. The pulley is made of material to support weight of suspended personal radiation protection garment 30. The pulley is operable to roll along the hanger 32, such that the pulley rolls along the hanger 32 when the operator 34 bends sideways. For example, when the operator 34 bends sideways, the pulley will roll along the hanger 32, such that the hanger 32 becomes tilted. This allows the operator 34 to freely move while the suspended personal radiation protection garment 30 remains properly suspended.

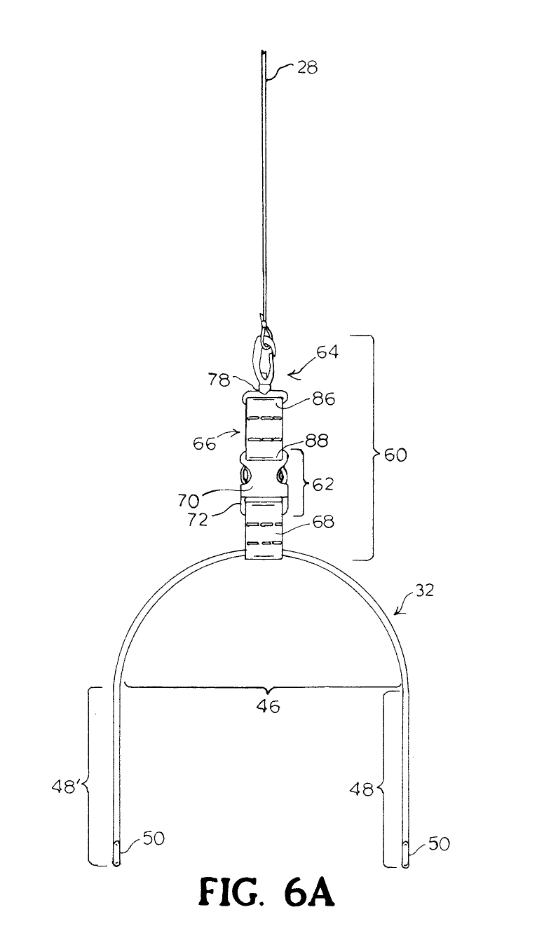

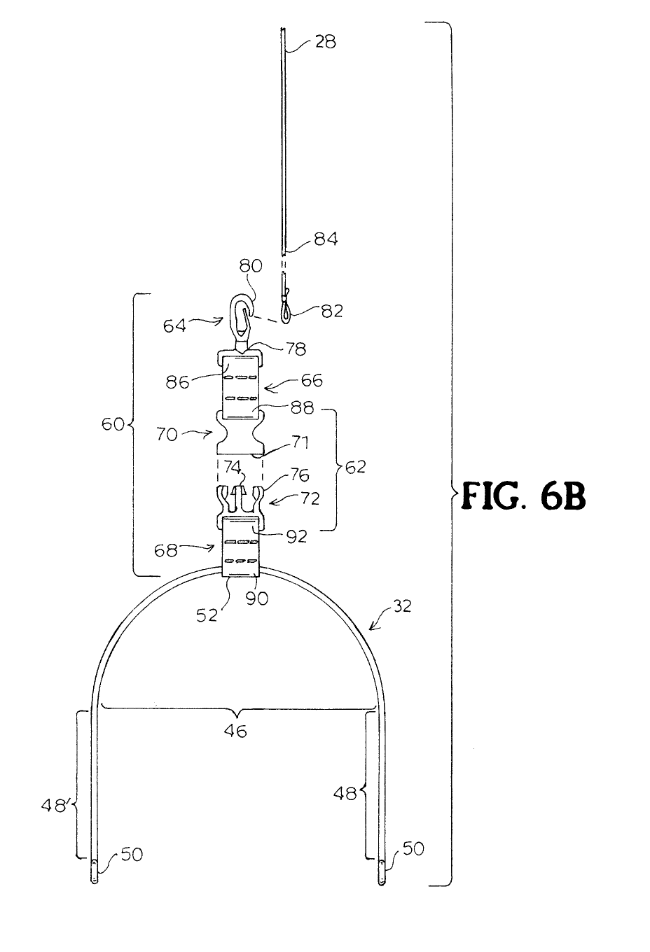

In another embodiment, the hanger 32 may be connected to the balancer 26 via a quick-connect means 60, as shown in FIGS. 6A and 6B. The quick-connect means 60 includes a buckle 62, clip 64, a strap 66 connecting the buckle 62 to the clip and a strap 68 connecting the buckle 62 to the hanger 32. The buckle 62 of the quick-connect means 60 includes a first section 70 and a second section 72. The first buckle section 70 includes a receiving portion 71 and the second buckle section 72 includes an insertion portion 74 so that the second buckle section 72 is operable to removably connect to the first buckle section 70. The second buckle section 72 may have one or more depressible regions 76 that can quickly and easily be depressed to release the second buckle section 72 from the first buckle section 70. The buckle 62 may be made of material to support weight of suspended personal radiation protection garment 30. Both the first and second buckle sections 70, 72 have sections operable to receive the straps 66, 68.

The clip 64 of the quick-connect system 60 includes a base 78 and a fastening portion 80. The base 78 portion is operable to receive the strap 66 from the first buckle section 70. The fastening portion 80 of the clip 64 is operable to snap onto a loop 82 in the cable, a hook, or a rod. The fastening clip portion 80 may clip onto a portion 84 of the balancer 26 or clip onto the loop 82 of the cable or a strap (not shown) that is attached to the balancer 26. The clip 64 is capable of swiveling, that is the base 78 and the fastening portion 80 rotate relative to one another, so as to minimize twisting of the quick-connect means 60. The clip 64 may be made of material to support weight of suspended personal radiation protection garment 30.

The clip 64 and the buckle 62 may be connected via the strap 66. One end 86 of the strap 66 may be attached to the clip 64 and the other strap end 88 is attached to the buckle 62. Each respective end 86, 88 of the strap 66 is doubled back onto itself and sewn so as to be permanently attached. The buckle 62 may also be attached to the bar 44 of the hanger 32 by the other strap 68. The first end 90 of the strap 68 is connected to the bar 44 of the hanger 32 while the other end 92 of the strap 68 is connected to the buckle 62.

The quick-connect system 60 is described above as an exemplary system. It is to be understood that any other quick-connect system may be used to disconnect the hanger 32 or the personal radiation protection garment 30 from the suspension system 20. Examples of other quick-connect systems may include Velcro, clips, snap connectors, electronic connecting devices, fasteners, other connectors, and the like. In one embodiment, the quick-connect system 60 can be a quick release pin that joins cable sections 28. The pin is removed manually or remotely, when desired, using a solenoid to linearly actuate the solenoid. The solenoid provides the linear action instead of manually actuating the pin. Also suitable as a quick-connect system is a quarter-turn fastener, a quick release clamp or latch, or a quick-connect coupling made of metal or plastic. A rip cord may also be used in combination with, for example, a Velcro strap that is pull to actuate a latch.

In accordance with an embodiment of the personal radiation protection garment suspension system 20, an exemplary method of operation is described below. The operator 34 of the suspension system 20 may present his personal radiation protection garment 30 to the suspension system 20. The personal radiation protection garment 30 may be any garment containing radiation-absorbing material. The personal radiation protection garment 30 may be of any shape, size or weight. The personal radiation protection garment 30 may be a full length protective garment, an apron, or a garment having any other amount of body coverage.

The hanger 32 may be pre-attached to the personal radiation protection garment 30 or to the suspension system 20. To attach the hanger 32 to the personal radiation protection garment 30, the connecting system 54 may be employed. As shown in FIG. 6, the shoulder area 55 of the personal radiation protection garment 30 connects to the connecting system 54 by looping the strap 58 of the connecting system 54 around the shoulder areas 55 of the garment 30 and buckling the two ends 61′, 59′ of the buckle 56 together. By doing this, the connecting system 54 effectively connects the hanger 32 to the personal radiation protection garment 30. The personal radiation protection garment 30 may be connected or disconnected from the hanger 32 at any time.

The operator 34 may attach the personal radiation protection garment 30 to the suspension system 20 by connecting the hanger 32 that has been pre-attached to the garment 30 to the suspension system 20, or attaching the garment 30 to the hanger 32 that has been pre-attached to the suspension system 20. The hanger 32 may be attached to the suspension system 20 using a quick-connect means 60, such as that previously described with respect to FIGS. 6A and 6B. The quick-connect means 60 acts as a means to quickly attach the personal radiation protection garment 30 to the suspension system 20 by connecting the ends 70, 72 of the buckle 62 together. The quick connect means 60 also acts as a means to quickly disconnect the garment 30 by depressing the insertion portion 74 of the buckle so that the ends 70, 72 of the buckle disconnect from each other.

After the personal radiation protection garment 30 is suspended from the suspension system 20, the operator 34 may step into the garment 30 by any means to attach the garment 30 to the operator 34. For example, in order to secure the personal radiation protection garment 30 to the operator 34, the operator 34 may wrap the garment 30 around the operator's body and secure the garment 30 to itself by Velcro, buckles, or any suitable fastening means for attaching two pieces of a heavy material together. The operator 34 or another individual can strap the personal radiation protection garment 30 closed, such that the garment 30 is secured to the operator's body. For example, if the suspended personal radiation protection garment 30 has a fastening means on the rear of the garment 30, then the operator 34 can walk up to the suspended garment 30. The operator 34 and/or an assistant can fasten the Velcro or buckles, such that the operator 34 can quickly and effortlessly put on the personal radiation protection garment 30 and receive radiation protection. The operator 34 can wear a sterile gown and sterile gloves in the normal manner.

In another embodiment, the operator 34 may be wearing the personal radiation protection garment 30 prior to connecting the garment 30 to the suspension system 20.

Regardless of the load attached to the counter-balancer 26, the cable extending from the counter-balancer 26 may remain extended so that the load, such as the personal radiation protection garment 30 and the hanger 32, only the hanger 32, the extended cable, a medical instrument, and the like, or any combination thereof, stays at a height where it is positioned by the operator 34. This allows the operator 34 to simply reach out and connect the suspended, extended cable of the counter-balancer 26 to the personal radiation protection garment 30, or the operator 34 can simply walk into a suspended garment 30 where the operator 34 last positioned it.

At any time, the operator 34 can adjust the weight the counter-balancer can support and the distance from the counter-balancer to the rail 22, as appropriate. For example, when the personal radiation protection garment 30 is attached to the suspension system 20, the operator 34 can adjust the balancer 26 to the desired counter-balancing weight. This would facilitate the operator 34 of the suspension system 20 to use various personal radiation garments 30 of different types or weight. Also, the length of the cable 28 may be adjusted so that the counter-balancer 26 is lowered to a particular height with respect to the ceiling 35 or floor.

Additionally, the hanger 32 is designed such that any personal radiation protection garment, including custom made garments or existing garments, may be easily attached. Because the hanger 32 is adapted to fit onto existing personal radiation protection garments, an operator 34 can use his preferred existing garment 30 with this system 20.

When operating with the suspension system 20, the operator 34 can move freely in the X-spatial plane and the Z-spatial plane while wearing the suspended personal radiation protection garment 30. The operator 34 can walk diagonally, crouch, or bend sideways in a free motion while receiving protection of the suspended personal radiation protection garment 30.

The operator 34 may also have motion in the Y-spatial and the Z-spatial plane to use the radiation device to properly treat the patient 40. The suspended personal radiation protection garment 30 may be substantially weightless to the operator 34, such that the operator 34 is comfortable and unhindered. The arms of the operator 34 may be able to freely move in order to properly treat the patient 40. The operator 34 can bend over the patient 40 without causing pain to, or asserting extra weight on, the spine of the operator 34.

The suspended personal radiation protection garment 30 properly protects the operator 34 from harmful radiation. Since the personal radiation protection garment 30 is suspended, the garment 30 can be heavier to provide more protection to the operator 34. The suspended personal radiation protection garment 30 may be substantially contoured to the body of the operator 34, such that a substantial area of the operator's body is protected. The suspended personal radiation protection garment 30 can also be made of thicker material to provide extra protection to the operator 34.

The operator 34 can move freely to return to the spot where the operator 34 initially stepped into the suspended personal radiation protection garment 30. The operator 34 or another individual can quickly and effortlessly unfasten or simply quick-disconnect the personal radiation protection garment 30 from the suspension system 20 via the quick-connect means 60 in order to disconnect the garment 30 from the suspension system 20. The operator 34 can easily step out from the suspended personal radiation protection garment 30. The personal radiation protection garment 30 may remain suspended without the cable from the balancer 26 re-coiling any of the extended cable, as previously described. For example, the personal radiation protection garment 30 can be removed from the suspension system 20 without the balancer 26 recoiling any of the extended cable. Alternatively, the hanger 32 can remain hooked to the personal radiation protection garment 30 or the counter-balancer 26.

The disconnecting point of the quick-connect means 60 may be at the counter-balancer 26, at the quick-connect means 60, or at the connecting system 54 connected to the hooks 50 of the hanger 32. Quick-disconnecting may be useful in emergency situations which occur during operating procedures. For example, it is not uncommon during a procedure in a cardiology catherization lab that a doctor must quickly move to another part of the room that is not covered by the suspension system 20, yet continue wearing the protective personal radiation protection garment 30. In this case, the quick-connect means 60 allows him to quickly disengage himself while wearing the protective personal radiation protection garment 30 from the suspension system 20, giving him full mobility about the radiation environment, such as having quick access the head or foot of the table, to perform various operations, such as intubating the patient or running a code.

The quick-connect means 60 may swivel. This swiveling capability allows the operator 34 to turn or twist in any direction without the suspension system 20 getting tangled or becoming twisted.

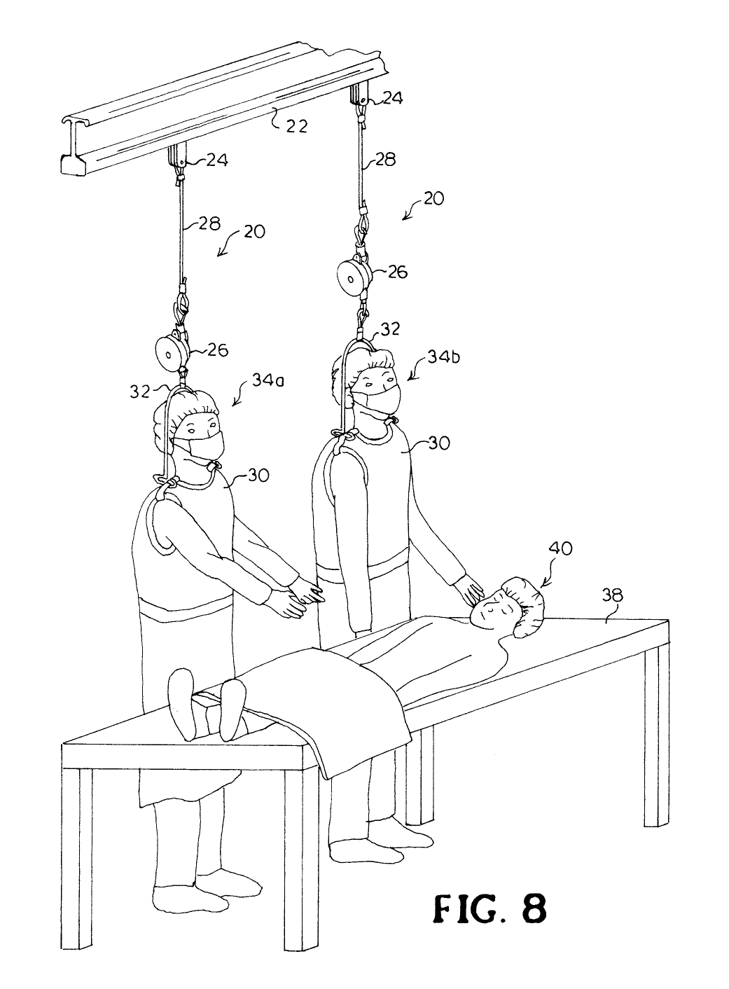

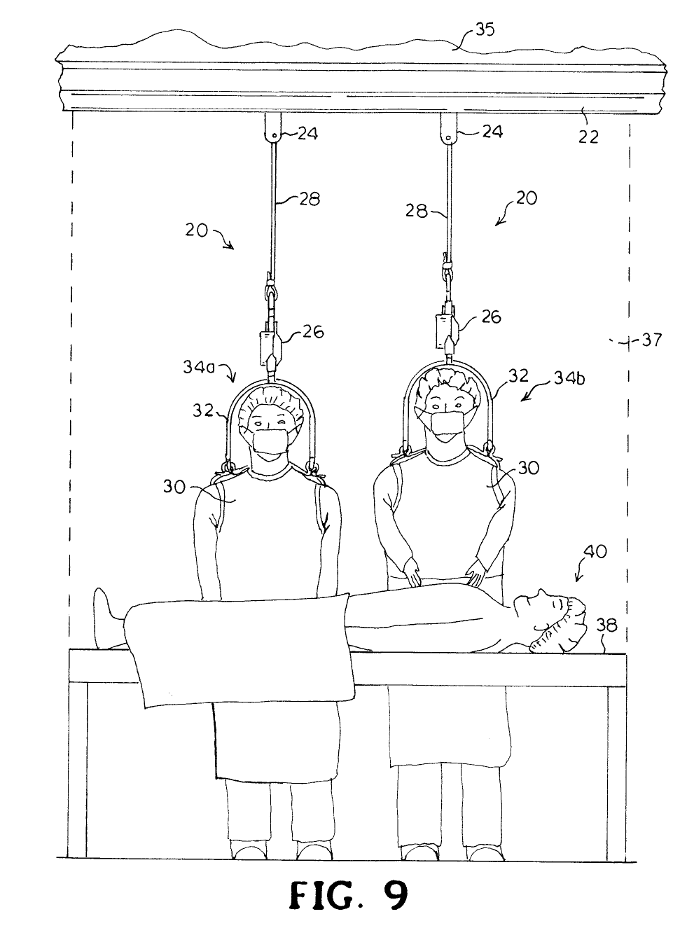

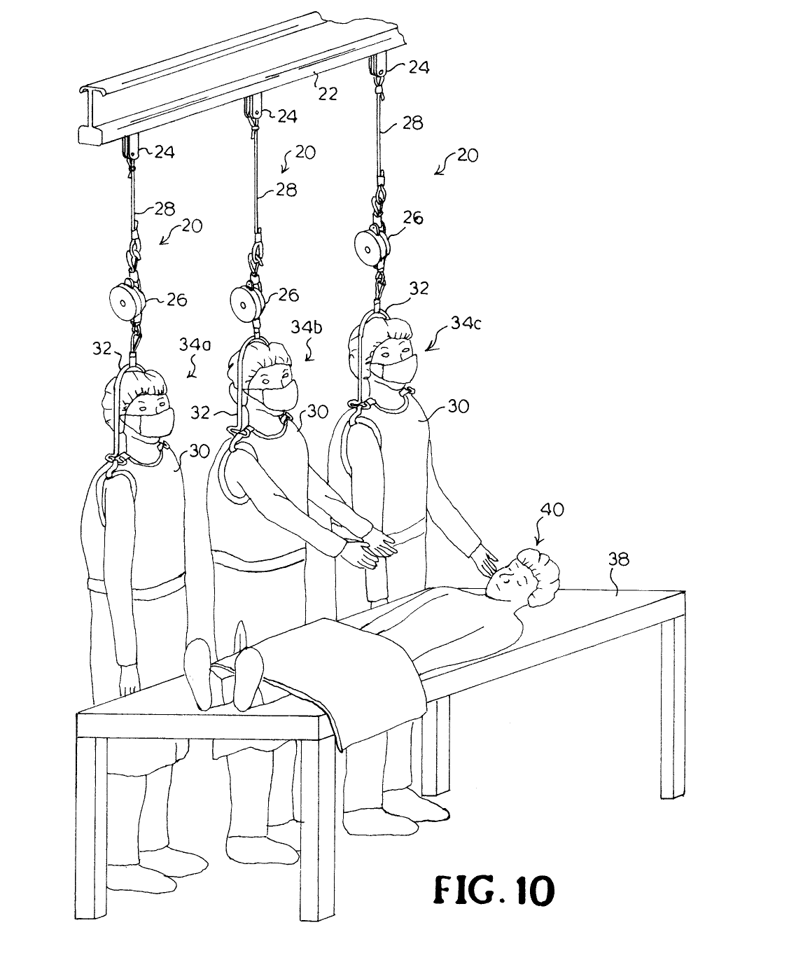

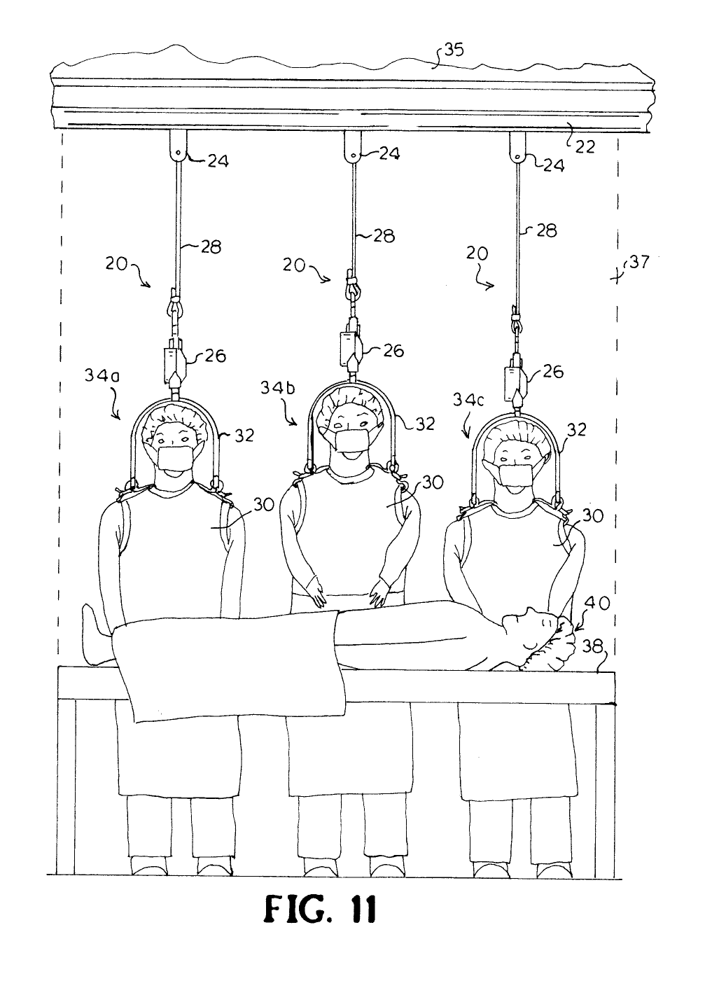

It should be appreciated that while this disclosure discusses hanging one personal radiation protection garment 30, any number of garments and/or medical devices, such as any medical tools, devices, and the like, may be suspended from the suspension system. This configuration is shown in FIGS. 8-11, which depict two and three operators 34, 34a, 34b utilizing the suspension system to suspend their personal radiation protection garments 30, 30a, 30b. Additionally, any number of suspension systems 20 may be employed to suspend one or more garments for personal radiation protection or to suspend medical tools, devices, and the like.

In accordance with the teachings of the present invention, the suspension system 20 is operable to suspend the personal radiation protection garment 30 such that the operator 34 is not hindered or burdened by the weight from the garment 30. The suspension system 20 allows the operator 34 to have complete freedom of motion in the X-spatial plane and the Z-spatial plane, which is commonly used during medical and research procedures. For example, this allows the operator 34 to move laterally along the side of an operating surface 38, such as the table or a medical bed. Also, the operator 34 can freely perform vertical motion activities, such as stooping, leaning, squatting, standing on an elevated surface. The tension the balancer 26 asserts on the personal radiation protection garment 30 can be designed so as to provide optimum relief of the garment's weight for the operator 34. This force can be constant in all positions by the operator 34.

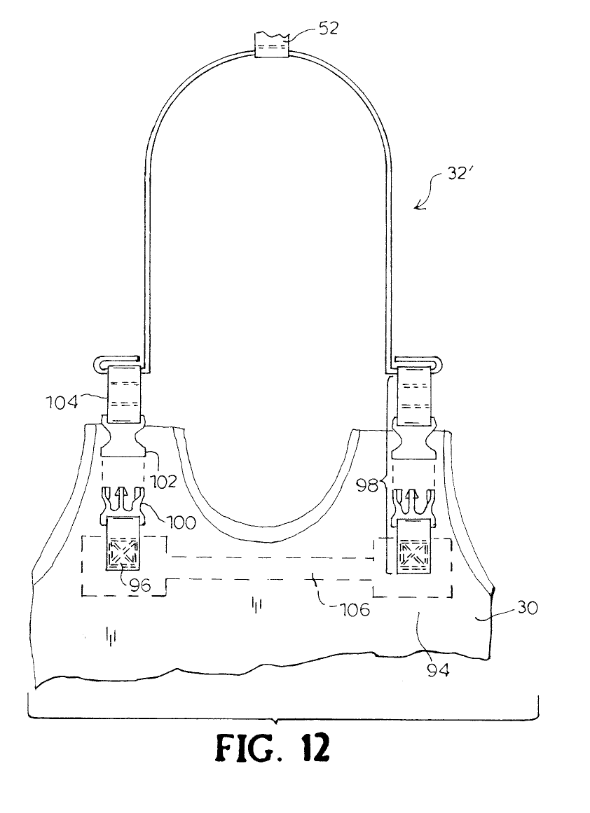

Referring to FIG. 12, the hanger 32 may be attached to a personal radiation protection garment 30, such as a lead apron, at a connecting area 94 on the rear surface of the garment. The connecting area 94 may be located below the level of the shoulder straps 55. For example, such connecting area 94 may be located adjacent the area where the shoulder blades (not shown) of a garment wearer makes contact with the garment 30. In this embodiment, the hanger 32 connects to the garment 30 via a pair of buckle connectors 98, each having a male buckle connector 100 and a female buckle connector 102. The male connector 100 attaches to the garment 30 via a strap 104, or other similar means, that is sewn into the garment 30 at the connecting area 94 located proximate to the shoulder-blade area of the garment 30. The female connector 102 is attached to the hanger 32 via a strap 105, or other similar means, to the hooks 50 or other similar connecting configuration. The male and female buckle connectors 100, 102 are operable to releasable connect with each other. It should be understood that both ends of the hanger 32 are connected to each respective connecting area 94 at the shoulder-blades of the garment 30.

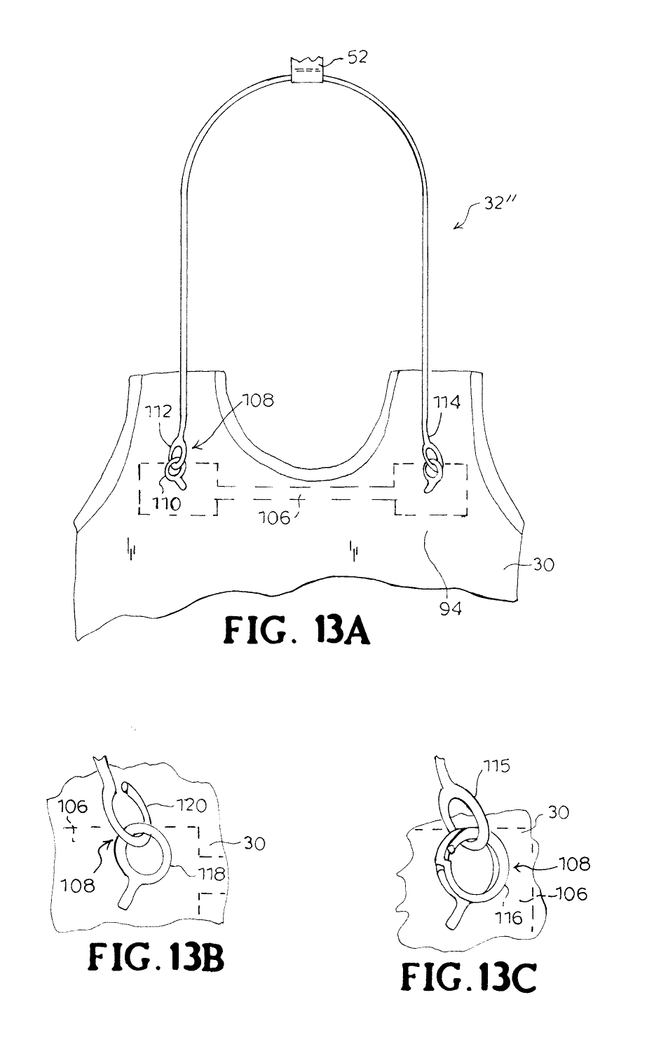

As shown in FIGS. 12 and 13A, the personal radiation protection garment 30 includes a reinforcing material or device 106. The reinforcing material 106 may be inserted inside of the personal radiation protection garment 30 during manufacture. This reinforcing material 106 may be a heavy gauge plastic or fiberglass or any other similar material that would bend across the back of a user for comfort but also helps to maintain the spacing of the ends of the hanger 32 or the distance between the shoulder blade areas 94 of the garment 30. This arrangement prevents the personal radiation protection garment 30 from bunching up when the garment 30 and the hanger 32 are suspended. The reinforcing material 106 may also act to reinforce the attachment of the attachment means, such as the buckles 100, 102 of the buckle connectors 98 or any other attachment system. For example, the connecting means may connect at the shoulder straps 55 as described above, wherein the rigid material 106 helps to maintain the spacing of the personal radiation protection garment 30 across the back. The attachment means, such as the straps on the buckles 100, 102 in the connector system 98, is sewn into the garment 30 directly adjacent, or into, the reinforcing material 106.

Referring now more particularly to the embodiment shown in FIGS. 13A-13C, the hanger 32 is attached to the garment 30 via a ring system 108. The ring system 108 connects the hanger 32 to the garment 30 at the connecting area 94 adjacent the shoulder blades of the personal radiation protection garment 30. The ring system 108 includes a garment ring 110 which connects to a hanger ring 112 located at the ends of the hanger 32. Each end of the hanger 32 may be bent slightly, as illustrated in FIG. 13A. The garment ring 110 is mechanically attached, such as by sewing, to the garment 30. The garment 30 includes the reinforcing material 106 to reinforce the space between the rings 110, 112 so that the garment 30 does not bunch up when suspended. The reinforcing material 106 would also act to reinforce the attachment of the rings 110, 112 to the garment 30.

In one embodiment, the garment ring 118 (FIG. 13B) is a closed loop member and the ring 120 at the end of the hanger 32 has a hook-like shape such that the hanger ring 120 is slightly open to receive the garment ring 118. In another embodiment, the ring 115 at then end of the hanger is a closed loop member 115 (FIG. 13C) and the garment ring 116 is configured similar to a key ring, as illustrated by reference numeral 116 of FIG. 13B. For example, the garment ring 110 may be a single member 116 configured in a loop and overlapping at least a portion of itself.

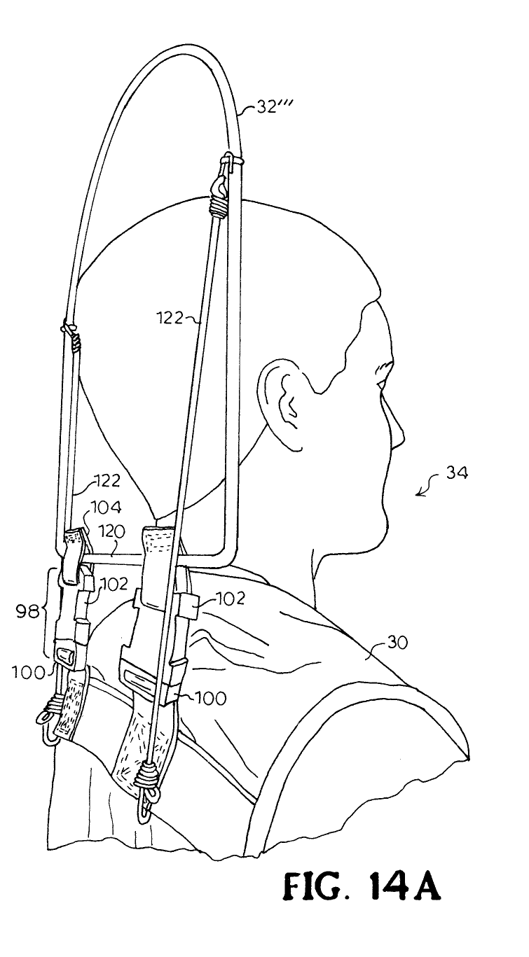

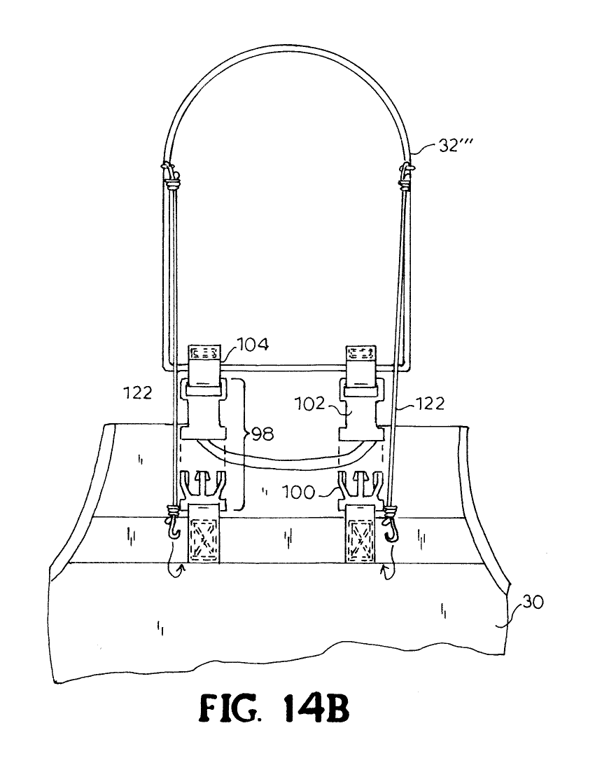

Another embodiment of a connecting system is shown in FIGS. 14A and 14B. In this embodiment, the ends of the hanger 32 are joined by a linear, rigid rod 120 that may be formed from the same material as the hanger 32. As such, the hanger 32 forms a continuous closed loop. The personal radiation protection garment 30 includes the reinforcing material 106. In this embodiment, the reinforcing material 106 is fixed to the outside of the personal radiation protection garment 30. This reinforcing material 106 may be a heavy woven fabric or other similar material that would bend across the back of a user for comfort but also helps to maintain the spacing between the shoulder blade areas 94 of the garment 30. The male connector 100 attaches to the garment 30 via a strap 104 sewn into the reinforcing material 106. The female connector 102 is attached to the hanger 32 via a strap 105 to the linear connecting rod. The male and female buckle connectors 100, 102 are operable to releasable connect with each other. Flexible cord 122 is provided between the arms 46 of the hanger 32 to provide mechanical impetus to ensure that the hanger 32 falls backward when the quickly disconnected from suspension. Any elastic material (spring, rubber band, etc.) could be used.

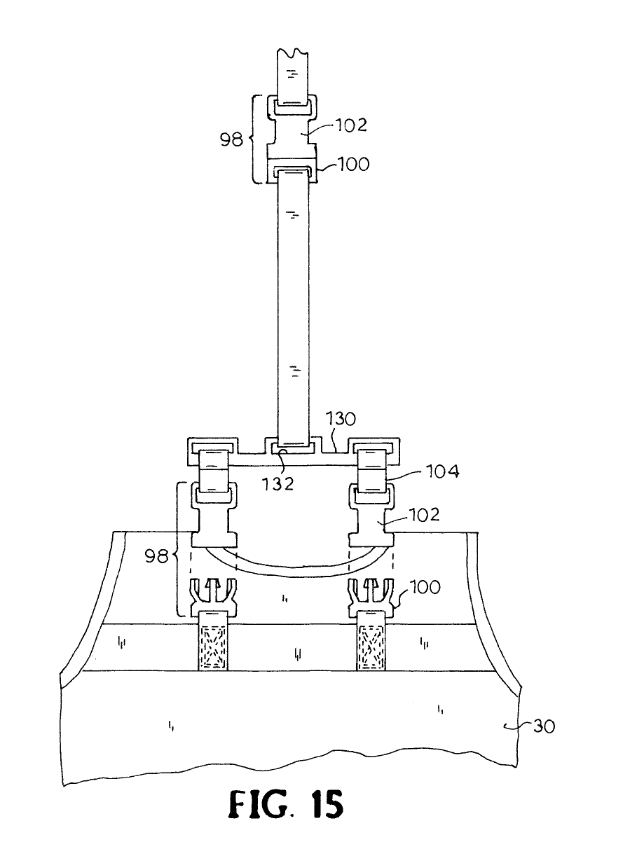

Referring now to FIG. 15, an embodiment of the connecting system 54 is shown which does not require a hanger 32. The female buckles 102 are connected to a rigid cross-piece 130. Intermediate the ends of the crosspiece 130 is a slot 132 for receiving, for example, the strap for quick-connect means.

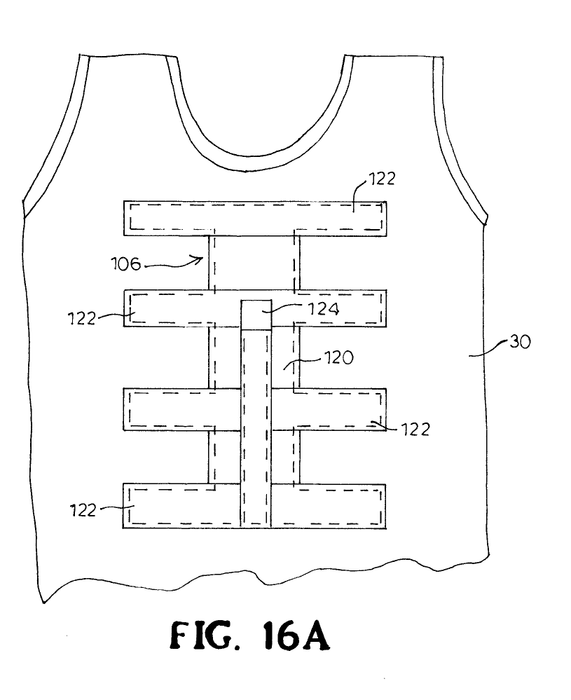

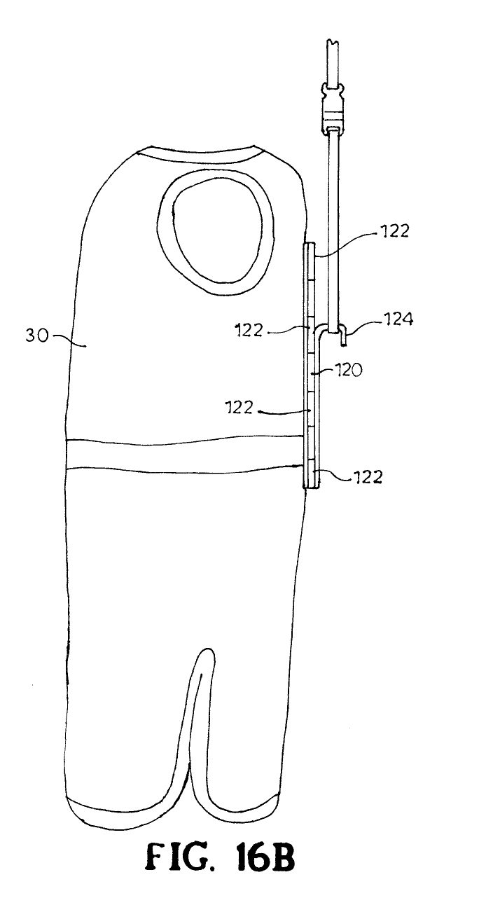

As shown in FIGS. 16A and 16B, in another embodiment the reinforcing material 106 for the personal radiation protection garment 30 may include a vertical member 120 extending adjacent the spine of the user. In this embodiment, the reinforcing material 106 may further comprise a plurality of vertically spaced horizontal members 122 extending from the vertical member 120 in the manner of ribs 122. This arrangement functions to maintain the rigidity and spacing of the back surface of the garment 30 across the back, particularly during suspension. The vertical member 120 of the reinforcing material 106 also acts to as the attachment means for a connecting means. As best seen in FIG. 16B, the connecting means is a hook member 124 directly attached to vertical member 120 of the reinforcing material 106. It is understood that any other suitable attachment system connecting to the reinforcing material 106 of the garment 30 could also be used.

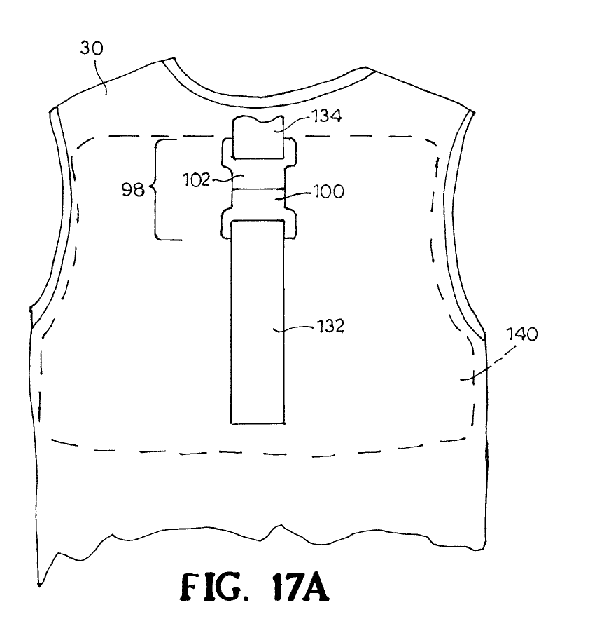

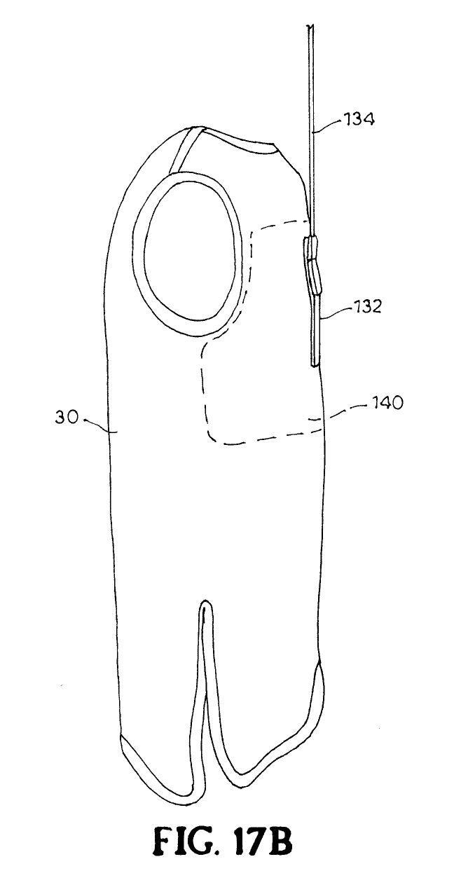

In still another embodiment, as shown in FIGS. 17A and 17B, reinforcing material 140 for the personal radiation protection garment 30 may comprise a single rigid member disposed inside the rear outer surface of the personal radiation protection garment 30 during manufacture. This reinforcing member 140 may be a heavy woven fabric, a heavy gauge plastic or fiberglass or any other similar material that would bend across the back of a user for comfort, but also help to maintain the rigidity of the garment 30 across the back, especially during suspension. This arrangement prevents the personal radiation protection garment 30 from bunching up when the garment 30 is suspended. The reinforcing member 140 may also function as the attachment means, such as for the buckles 100, 102 of buckle connectors 98, although it is understood that any other attachment system may be used. For example, the connecting means may connect vertically along the reinforcing member 140 adjacent the spine of the user. The attachment means, such as the straps on the buckles 100, 102 in the connector system 98, is sewn into the garment 30 directly adjacent, or into, the reinforcing member 140. The male connector 100 attaches to the garment 30 via a strap 132 sewn into the reinforcing member 140. The female connector 102 is attached to the hanger 32 via a strap 134. The male and female buckle connectors 100, 102 are operable to releasably connect with each other.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. An apparatus for suspending a personal radiation protection garment above a work surface defining an area, the suspension apparatus comprising:
a support member adapted to be positioned above the work surface;
a cable mechanically suspended from the support member;
means for counter-balancing the weight of the personal radiation protection garment, the counter-balancing means attached to the cable; and
means for attaching the counter-balancing means to the personal radiation protection garment for suspending the personal radiation protection garment, the attaching means including
means for disconnecting the garment from the counter-balancing means, the disconnecting means manually operable by one hand of a user and disposed within reach of the user while wearing the personal radiation protection garment attached to the counter-balancing means,
wherein the personal radiation protection garment is supported in suspension when attached to the counter-balancing means, and wherein the personal radiation protection garment may be disconnected from the counter-balancing means by the one hand of the user for releasing the personal radiation protection garment from suspension while still being worn by the user.

2. The apparatus as recited in claim 1, wherein the counter-balancing means comprises a zero gravity balancer.

3. The apparatus as recited in claim 2, wherein the zero gravity balancer is operable to balance weight substantially equal to the weight of the personal radiation protection garment.

4. The apparatus as recited in claim 1, wherein the counter-balancing means comprises a spring balancer.

5. The apparatus as recited in claim 1, wherein the counter-balancing means comprises at least one counterweight.

6. The apparatus as recited in claim 1, wherein the counter-balancing means comprises an air balancer.

7. The apparatus as recited in claim 1, wherein the counter-balancing means comprises a pneumatic balancer.

8. The apparatus as recited in claim 1, wherein the counter-balancing means comprises a spring motor.

9. The apparatus as recited in claim 1, wherein the support member comprises a rail having a longitudinal axis; and a trolley disposed on the rail for movement relative to the rail along the longitudinal axis, wherein the cable is connected to the trolley.

10. The apparatus as recited in claim 9, wherein the rail comprises a means for attaching to the ceiling of a room.
